(19) United States
(12) Patent Application Publication
(10) Pub. No.: US 2025/0230290 A1
(43) Pub. Date: Jul. 17, 2025

(54) CROSSLINKABLE THERMOPLASTICS

(71) Applicant: KANEKA CORPORATION, Osaka (JP)

(72) Inventors: Quyen Nguyen, Pasadena, TX (US); Omar De Anda, Pasadena, TX (US); Tianlei Zhou, Pasadena, TX (US); Young Hoon Lim, Pasadena, TX (US)

(73) Assignee: KANEKA CORPORATION, Osaka (JP)

(21) Appl. No.: 18/697,645

(22) PCT Filed: Oct. 27, 2022
(86) PCT No.: PCT/US2022/048002

§ 371 Date: Apr. 1, 2024

Related U.S. Application Data
(60) Provisional application No. 63/273,685, filed on Oct. 29, 2021.

(51) Int. Cl. C08J 3/24; C08J 3/00; C08J 5/24

(52) U.S. Cl. CPC C08J 3/246; C08J 3/005; C08J 5/241; C08J 2371/10; C08J 2463/00

(57) ABSTRACT

A pre-preg composite includes a thermoplastic-thermosetting resin composition and fibers, re-moldability of a molded part prior to final cure, and is capable of being final cured in a free-standing state. The thermoplastic-thermosetting resin includes a crosslinkable thermoplastic resin and a thermosetting resin. A method of making the pre-preg is provided. A method of forming a thermoset article from the pre-preg composite is also provided. The method includes providing a pre-preg composite, pre-curing the pre-preg composite such that the pre-preg composite is cured to an extent of from 2% to 80%, and curing the pre-cured pre-preg composite to form the thermoset article.

### BACKGROUND

Thermosets and thermoplastics are distinct classes of polymers, distinguished from each other based on their behavior in the presence of heat. Specifically, thermoplastics such as polyethylene (PE), polycarbonate (PC), and polyetheretherketone (PEEK) become pliable or moldable upon application of heat (solidifying upon cooling), whereas thermosets such as epoxy, benzoxazine, and bismaleimide are irreversibly hardened upon curing, and cannot be melted or reshaped on heating. Thus, thermoplastic materials have melt temperatures (melting point) where they start to flow, while thermoset products can withstand higher temperatures without loss of their structural integrity once cured.

Thermoplastics are generally classified into three groups based on their mechanical and/or thermal properties. First are commodity plastics represented by PE, polyvinyl chloride (PVC), polystyrene (PS), and so on, which are widely used for applications such as packaging materials, food containers, and household products. Second are engineering plastics represented by PC, polyamide (PA), polyoxymethylene, and so on, which generally show better thermal and mechanical properties than commodity plastics, e.g., greater than 50 MPa of tensile strength and greater than 2.5 GPa of flexural modulus at temperatures above 100° C. Third are super engineering plastics represented by PEEK, polyetherimide and polyphenylene, which can be continuously used at temperatures above 150° C. They exhibit outstanding mechanical and thermal properties arising from rigid polymer backbone-based aromatic rings and stable second-order structures. While commodity thermoplastics have high processing efficiency in manufacturing, the super engineering plastics generally have difficulty in being molded, and require extremely high process temperatures (>300° C.) to exhibit good flow above their melting points.

Thermoset plastics generally show high modulus and superior creep resistance in comparison to thermoplastics due to their three-dimensional network of bonds achieved upon crosslinking (curing). This results in their elongation-at-break values being lower than thermoplastics. They also generally require long periods of cure time at temperatures ranging as high as 250° C.

Polymer alloys (blended polymers) composed of a blend of both thermoplastic compositions and thermoset compositions can provide desirable characteristics of both polymer types while mitigating less desirable features. Optimally, thermoplastic polymer chains can penetrate into the network structure of the cured thermoset component to form homogeneous semi-interpenetrated structures. However, there may be poor miscibility of thermoplastic components with thermoset components due to the phase separation, and it has proven difficult to combine these two materials to form stable polymer alloys with better thermal and/or mechanical properties.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a pre-preg composite, comprising a thermoplastic-thermosetting resin composition and fibers, where the pre-preg composite is capable of being cured in a free-standing state. The thermoplastic-thermosetting resin includes a crosslinkable thermoplastic resin and a thermosetting resin.

In another aspect, embodiments disclosed herein relate to method of making a pre-preg composition. The method includes impregnating fibers with a thermoplastic-thermosetting resin composition. The thermoplastic-thermosetting resin composition includes a crosslinkable thermoplastic resin and a thermosetting resin, and the pre-preg composition is capable of being cured in a free-standing state.

In yet another aspect, embodiments disclosed herein relate to a method of forming a thermoset article. The method includes providing a pre-preg composite, pre-curing the pre-preg composite such that the pre-preg composite is cured to an extent of from 2% to 80%, and curing the pre-cured pre-preg composite to form the thermoset article.

Other aspects and advantages of the claimed subject matter will be apparent from the following description and the appended claims.

### BRIEF DESCRIPTION OF DRAWINGS

FIG. 1 is a schematic showing pre-preg processing into a thermoset with free-standing curing in accordance with one or more embodiments.

FIGS. 2A and 2B are photographs of a welded/co-cured aramid and aluminum honeycomb core with pre-preg face skins in accordance with one or more embodiments.

FIG. 3 is a photograph of a shaped and pre-cured, then cured thermoset article in accordance with one or more embodiments.

FIG. 4 is a reaction scheme for making a thermoplastic resin in accordance with one or more embodiments.

FIG. 5 is a plot showing the viscosity of various resins in accordance with one or more embodiments.

FIG. 6 is a plot showing the viscosity of resins over time at a constant temperature in accordance with one or more embodiments.

FIG. 7 is a photograph of an impregnated carbon fabric with a thermoplastic-thermosetting resin composition in accordance with one or more embodiments.

FIG. 8 is a plot showing the modulus versus temperature of resins that were subjected to different curing conditions in accordance with one or more embodiments.

FIG. 9 is a DSC plot showing heat flow of samples subjected to different curing conditions in accordance with one or more embodiments.

FIG. 10 is a plot showing the modulus versus temperature of resins that were subjected to different pre-cure conditions in accordance with one or more embodiments.

FIG. 11 is a photograph of cured thermosets having been subjected to different pre-cure times in accordance with one or more embodiments.

FIG. 12 is a photograph of cured thermosets having been subjected to different pre-cure temperatures in accordance with one or more embodiments.

FIG. 13 is a photograph of cured thermosets having different reinforcing fibers in accordance with one or more embodiments.

### DETAILED DESCRIPTION

In one aspect, embodiments disclosed herein relate to composites formed with a thermoplastic-thermosetting resin composition, which may also be referred to as an advanced thermoset composition. The thermoplastic-thermosetting resin composition may be considered an advanced thermoset due to its hybrid thermoplastic and thermosetting properties, which are advantageous for processing pre-pregs into thermosets. The advanced thermoset composition may be used to form a pre-preg (i.e., a composite of a fiber and a resin in which the fiber has been pre-impregnated with the resin) that has unique thermoplastic properties when in an uncured and in a partially-cured state, but which behaves like a thermoset when in a final cured state. In an uncured state, the advanced thermoset composition has thermoplastic properties and may impregnate fibers under conditions used with conventional thermosets. Once impregnated with the advanced thermoset composition and partially-cured, the pre-preg behaves as a traditional thermoplastic material. It may be molded under mild heating into desired shapes. The composite can hold or maintain a desired shape during a final curing process in which the pre-preg is cured into a thermoset. The partially-cured pre-preg can be remolded under mild heating any number of times to achieve complex shapes that may be difficult to achieve with traditional thermoplastics. Such properties allow for a simpler curing process to form a thermoset. Typically, equipment such as molds, autoclaves, and/or vacuum bags are required for a pre-preg to hold its shape during the final curing process. No such equipment is needed for the free-standing pre-cured pre-pregs of the present disclosure, which allows for the pre-pregs to be cured using a simple heating process.

One or more embodiments of the present disclosure relate to a pre-preg composite that includes a thermoplastic-thermosetting resin composition and fibers. The thermoplastic-thermosetting resin includes a crosslinkable thermoplastic resin and a thermosetting resin used in combination to form a resin suitable for forming the pre-preg composite. In one or more embodiments, the thermoplastic resin provides the unique moldability of the pre-preg, while the thermosetting resin may be used to tune the viscosity for optimal pre-preg processing.

The thermoplastic-thermosetting resin composition in accordance with one or more embodiments includes a crosslinkable thermoplastic resin. The crosslinkable thermoplastic resin may itself provide a combination of properties not achievable with thermosets or thermoplastics alone.

For example, in one or more embodiments, the crosslinkable thermoplastic resin may include a polymeric backbone formed from a thermoplastic unit, and at least one crosslinkable group bonded to the thermoplastic unit. The thermoplastic unit may be selected based on the desired properties for the thermoplastic (and end application) and may be selected from, for example, polyimides (PI), polyetherimides (PEI), polyaryl ether ketones (PAEK), polyphenylene sulfides (PPS), polysulfones (PSU), and polyamide-imides (PAI). PAEKs may include, for example, polyether ether ketones (PEEK) and polyether ketone ketones (PEKK). PSUs may include, for example, poly (arylene) sulfones (PAS), polyether sulfones (PES), and polyphenylene sulfones (PPSU).

The hybrid resins involve cross-linkable groups, as a single endcap or double endcaps, as part of the polymer backbone, or as pendent groups arising off of the polymer backbone. For example, in the case of benzoxazine resins, the hybrid resin may include repeating units with a benzoxazine functionality that may subsequently crosslink through a ring opening. In some embodiments, these cross-linkable groups can be introduced into a polymer structure by a reaction between functional groups of a resin and a compound having a cross-linking group. In some embodiments, the compound having cross-linkable groups can be used as one of the monomers when a resin is synthesized. Methods of introducing cross-linkable groups may include, but are not limited to, solvent-based reactions, and melt state reactions such as by way of extruder, oven, hot press, autoclave, and so on. In some embodiments, these cross-linkable groups can be reacted with each other to form a polymerized structure by external stimuli such as heat, ultraviolet irradiation, microwave irradiation, moisture, and so on. In some embodiments, these external stimuli may be independently used for curing these cross-linkable thermoplastic resins. In some embodiments, two or more stimuli may be used for curing these cross-linkable thermoplastic resins at the same time. In some embodiments, two or more external stimuli may be used at separate times for making partially-cured (pre-cured) intermediates of cross-linkable thermoplastic resins, followed by full curing. In some embodiments, compounds capable of reacting by external stimuli may be used for curing along with cross-linkable thermoplastic resins to be cross-linked together. For example, the cross-linkable groups activated by heat may include, but are not limited to, epoxy, benzoxazine, nitrile, bismaleimide, citraconic imide, and other unsaturated hydrocarbon groups such as nadic imide, phenylethynyl, and phenylethynyl imide, and so on. The cross-linkable groups activated by ultraviolet may include, but are not limited to, acrylic, methacrylic, cinnamic, allyl azide, and other unsaturated hydrocarbon groups. In some embodiments, these cross-linkable groups can be used independently. In other embodiments, two or more cross-linkable groups can be used together. Also, for example, the cross-linkable groups by microwave irradiation may include, but are not limited to, epoxy and other unsaturated hydrocarbon groups. These cross-linkable groups may be used independently or together. The cross-linkable groups by moisture absorption may include, but are not limited to, cyanoacrylate, isocyanate, and alkoxysilanes. These cross-linkable groups may be used with catalysts for accelerating the cure reaction.

Examples of crosslinkable thermoplastic resins include those described in PCT/IB2021/020016 and PCT/IB2021/020018, which are herein incorporated by reference in their entirety.

In one or more embodiments, the crosslinkable thermoplastic resin is a benzoxazine resin. The benzoxazine resin comprises at least one benzoxazine moiety having formula (I),

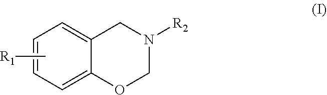

where each of R₁ and R₂ may represent one or more of a hydrogen atom, a hydrocarbon group, a substituted hydrocarbon group, a functional group, or a second BZ moiety. As used throughout this description, the term “hydrocarbon group” may refer to branched, straight chain, and ring-containing hydrocarbon groups, which may be saturated or unsaturated. The hydrocarbon groups may be primary, secondary, and/or tertiary hydrocarbons. As used throughout this description, the term “substituted hydrocarbon group” may refer to a hydrocarbon group (as defined above) where at least one hydrogen atom is replaced with a non-hydrogen group, resulting in a stable compound. Such substituents may be groups selected from, but are not limited to, halo, hydroxyl, alkoxy, oxo, alkanoyl, aryloxy, alkanoyloxy, amino, alkylamino, arylamino, arylalkylamino, disubstituted amines, alkanylamino, aroylamino, aralkanoylamino, substituted alkanoylamino, substituted arylamino, substituted aralkanoylamino, thiol, alkylthio, arylthio, arylalkylthio, alkylthiono, arylthiono, aryalkylthiono, alkylsulfonyl, arylsulfonyl, arylalkylsulfonyl, sulfonamide, substituted sulfonamide, nitro, cyano, carboxy, carbamyl, alkoxycarbonyl, aryl, substituted aryl, guanidine, and heterocyclyl, and mixtures thereof. The functional groups may be groups selected from, but are not limited to, halo, hydroxyl, alkoxy, oxo, amino, amido, thiol, alkylthio, sulfonyl, alkylsulfonyl, sulfonamide, substituted sulfonamide, nitro, cyano, carboxy, carbamyl, alkoxycarbonyl groups, and the like.

In one or more particular embodiments, the crosslinkable thermoplastic resin may be a benzoxazine resin having the structure as shown in Formula (II),

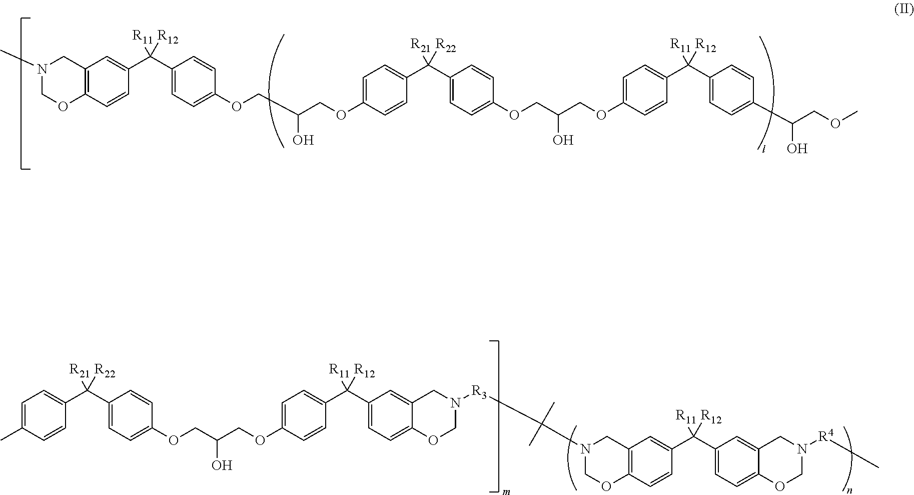

where each of R₁₁, R₁₂, R₂₁, and R₂₂ may represent one or more of a hydrogen atom or a hydrocarbon group, respectively. Each of R₃ and R₄ may represent backbone structure of diamines having 6 to 27 carbon atoms, such as bis[4-(3-aminophenoxy)phenyl]sulfone (BAPS-m), bis[4-(4-aminophenoxy)phenyl]sulfone (BAPS-p), 1,4-diaminobenzene (PPD), 1,3-diaminobenzene (MPD), 2,4-diaminotoluene (2,4-TDA), 4,4′-diaminodiphenylmethane (MDA), 4,4′-diaminodiphenylether (ODA), 3,4′-diaminodiphenylether (DPE), 3,3′-dimethyl-4,4′-diaminobiphenyl (TB), 2,2′-dimethyl-4,4′-diaminobiphenyl (m-TB), 2,2′-bis(trifluoromethyl)-4,4′-diaminobiphenyl (TFMB), 3,7-diamino-dimethyldibenzothiophen-5,5-dioxide (TSN), 4,4′-diaminobenzophenone, 3,3′-diaminobenzophenone, 4,4′-bis(4-aminophenyl) sulfide (ASD), 4,4′-diaminodiphenyl sulfone (ASN), 4,4′-diaminobenzanilide (DABA), 1,n-bis(4-aminophenoxy) alkane (n=3, 4 or 5, DAnMG), 1,3-bis(4-aminophenoxy)-2,2-dimethylpropane (DANPG), 1,2-bis[2-(4-aminophenoxy) ethoxy] ethane (DA3EG), 1,5-bis(4-aminophenoxy) pentane (DA5MG), 1,3-bis(4-aminophenoxy) propane (DA3MG), 9,9-bis(4-aminophenyl) fluorene (FDA), 5 (6)-amino-1-(4-aminomethyl)-1,3,3-trimethylindan, 1,4-bis(4-aminophenoxy)benzene (TPE-Q or APB-144), 1,3-bis(4-aminophenoxy)benzene (TPE-R or APB-134 or RODA), 1,3-bis(3-aminophenoxy)benzene (APB or APB-133)), 4,4′-bis(4-aminophenoxy) biphenyl (BAPB), 4,4′-bis(3-aminophenoxy) biphenyl, 2,2-bis(4-aminophenoxyphenyl) propane (BAPP), 2,2-bis[4-(4-aminophenoxy)phenyl] hexafluoropropane (HFBAPP), 3,3′-dicarboxy-4,4′-diaminodiphenylmethane (MBAA), 4,6-dihydroxy-1,3-phenylenediamine (known as 4,6-diaminoresorcin), 3,3′-dihydroxy-4,4′-diaminobiphenyl (HAB), and 3,3′,4,4′-tetraminobiphenyl (TAB); aliphatic or alicyclic diamine compounds having 6 to 24 carbon atoms, such as 1,6-hexamethylenediamine (HMD), 1,8-octamethylenediamine (OMDA), 1,9-nonamethylene diamine, 1,12-dodecamethylene diamine (DMDA), 1-amino-3-aminomethyl-3,5,5-trimethylcyclohexane, 4,4′-dicyclohexylmethanediamine, and cyclohexanediamine; silicone-based diamine compounds such as 1,3-bis(3-aminopropyl)-1,1,3,3-tetramethyldisiloxane and polydimethyl siloxane (PDMS) and diamines based on a predominantly polyethylene glycol backbone. The value of 1 may range from 0.01 to 10, or from 0.02 to 5, or from 0.05 to 2, or from 0.1 to 1. In one or more embodiments, 1 ranges from 0.1 to 0.5 for flexibility of the thermoplastic-thermosetting resin. In one or more embodiments, 1 ranges from 0.5 to 1 for more flexibility of the thermoplastic-thermosetting resin. The ratio of n to m (that is n/m), may range from 0.1 to 100, or from 0.2 to 50, or from 0.5 to 20, or from 1 to 10. In one or more embodiments, n/m ranges from 1 to 5 for flexibility of the thermoplastic-thermosetting resin. The value of m may range from 1 to 1000, or from 1 to 500, or from 1 to 200, or from 1 to 100. The value of n may range from 1 to 1000, or from 1 to 500, or from 1 to 200, or from 1 to 100.

The cross-linkable thermoplastic resin may be included in the thermoplastic-thermosetting resin composition in an amount ranging from 20 to 99 wt. % (weight percent) based on the total amount of resin in the composition. In one or more embodiments, the crosslinkable thermoplastic resin amount may have a lower limit of one of 20, 22, 25, 27, 30, 32, 35, 37, and 40 wt. %, and an upper limit of one of 40, 42, 45, 47, 50, 52, 55, 57, 60, 65, 70, 75, 80, 85, 90, 95, 99, 99.9 and 100 wt. %, based on the total amount of resin in the composition, where any lower limit may be paired with any upper limit.

As noted above, the thermoplastic-thermosetting resin composition also includes a thermosetting resin. The thermosetting resin may be any suitable resin provided it can be used to adjust the viscosity of the resin such that it is suitable for pre-preg processing. In one or more embodiments, the thermosetting resin is selected from the group consisting of an epoxy resin, a benzoxazine resin, and combinations thereof.

In one or more embodiments, the thermosetting resin is an epoxy resin. In embodiments in which the thermosetting resin is an epoxy resin, the epoxy resin is not particularly limited, provided that the epoxy resin is a compound having an epoxy group. In one or more embodiments, the epoxy resin may be a polyepoxide. The epoxy resin may be a polyglycidyl ether, such as addition reaction products of polyhydric phenols. Addition reaction products of polyhydric phenol may include, but are not limited to, bisphenol A, bisphenol F, bisphenol, and phenol novolac with epichlorohydrin. The epoxy resin may include polyglycidylamine compounds from monoamines and polyamines such as aniline, diaminobenzene, aminophenol, phenylenediamine, and diaminophenylether. Alicyclic epoxy resins having an alicyclic epoxy structure may also be included, such as cyclohexylepoxy. Other suitable epoxy resins may include addition reaction products of polyhydric alcohols and epichlorohydrin halogenated epoxy resins in which hydrogen is partially substituted with halogen elements such as bromine; and homopolymers or copolymers made from the polymerization of monomers containing unsaturated monoepoxide such as allylglycidyl ether. In particular embodiments, the epoxy resin may be diglycidyl ether of bisphenol A (DGEBA). The previously-described epoxy resins may be used alone or in combination.

In one or more embodiments, the thermosetting resin is a benzoxazine resin. The benzoxazine resin may include at least one benzoxazine moiety as shown in Formula (I) above. The benzoxazine thermosetting resin may have a structure as shown in Formulas (III)-(VI).

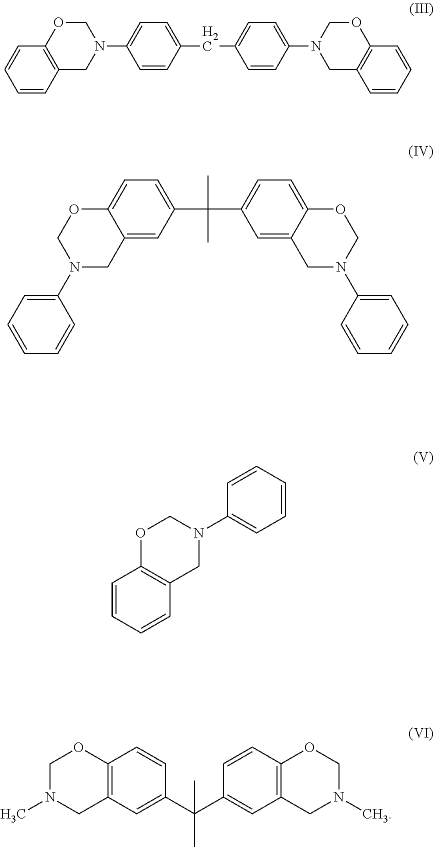 [SMILES: c1ccc2c(c1)CN(c1ccc(Cc3ccc(N4COc5ccccc5C4)cc3)cc1)CO2 ; CC(C)(c1ccc2c(c1)CN(c1ccccc1)CO2)c1ccc2c(c1)CN(c1ccccc1)CO2 ; c1ccc(N2COc3ccccc3C2)cc1 ; CN1COc2ccc(C(C)(C)c3ccc4c(c3)CN(C)CO4)cc2C1]

The thermosetting resin may be included in the thermoplastic-thermosetting resin composition in an amount ranging from 1 to 60 wt. % (weight percent), based on the total amount of resin in the composition. In one or more embodiments, the thermosetting resin amount may have a lower limit of one of 1, 2, 5, 10, 12, 15, 20, 25, and 30 wt. %, and an upper limit of one of 32, 35, 40, 42, 45, 47, 50, 52, 55, 57, and 60 wt. %, based on the total amount of resin in the composition, where any lower limit may be paired with any upper limit.

The thermoplastic-thermosetting resin composition may also optionally include a catalyst. Suitable catalysts may include inorganic salts, organic compounds, or a combination thereof.

The amount of catalyst may be selected based upon the amount and type of thermosetting resin in the composition. For example, in one or more embodiments, the catalyst may be included in an amount ranging from about 0.1 to 10.0 wt. %, based on the total amount of the thermosetting resin. The amount of catalyst may have a lower limit of one of 0.1, 0.2, 0.5, 1.0, 1.5, 2.0, 2.5, 3.0, 3.5, 4.0, 4.5 and 5.0 wt. %, and an upper limit of one of 5.5, 6.0, 6.5, 7.0, 7.5, 8.0, 8.5, 9.0, 9.5, and 10.0 wt. %, based on the total amount of the thermosetting resin.

Prior to its inclusion in a pre-preg composite, the thermoplastic-thermosetting resin composition may have a viscosity suitable for processing into a pre-preg. For example, in one or more embodiments, the resin composition may have a complex viscosity ranging from about 0 to 1000 Pa·S, or from about 0 to 100 Pa-S, in a temperature ranging from about 50 to 140° C. when tested according to ASTM D7891. As noted previously, the viscosity of the resin composition may be tuned for a particular pre-preg process by adjusting the ratio of the thermoplastic resin to the thermosetting resin. Generally, a higher relative amount of the thermosetting resin provides a reduction in viscosity of the resin composition. If too little thermosetting resin is included in the resin composition, the viscosity may be too high for processing into a pre-preg. However, if too much thermosetting resin is included, the thermoplastic-thermosetting resin may lose its thermoplastic properties, and thus its unique moldability characteristics.

The pre-preg composite of one or more embodiments also includes fibers. The fibers may be selected based on the desired properties (and application) and may include inorganic fiber such as carbon fiber, glass fiber, metal fiber, and ceramic fiber, as well as organic synthetic fiber such as aramid fiber, polyamide fiber, polyester-based fiber, polyolefin-based fiber, and novoloid fiber. The fibers may be used alone or in combination.

The pre-preg composition may include the thermoplastic-thermosetting resin in an amount ranging from 40-60 wt. %, based on weight of the resin to the total weight of the pre-preg (i.e. resin and fiber).

The prepreg may include other additives, which may include but are not limited to tackifiers, tougheners, and fillers.

As noted above, the thermoplastic-thermoset hybrid resin composition disclosed herein may be impregnated into fibers to form a pre-preg. Specifically, the resin as discussed above may be combined with reinforcement fibers to form a composite material or structure, such as prepregs formed by impregnating a layer or weave of fibers with resin. A resin film may be formed from the resin by, for example, compression molding, extrusion, melt-casting, or belt-casting, followed by laminating such film to one or both opposing surfaces of another layer, including for example a layer of reinforcement fibers in the form of, for example, a non-woven mat of relatively short fibers, a woven fabric of continuous fibers, or a layer of unilaterally aligned fibers (i.e., fibers aligned along the same direction), at temperature and pressure sufficient to cause the resin film to flow and impregnate the fibers. In one or more embodiments, the reinforcement fiber may be impregnated with the thermoplastic-thermosetting resin using compression at a temperature ranging from 100° C. to 120° C. and an external pressure of 0.5 MPa to 3.5 MPa. Under such conditions, the thermoplastic-thermosetting resin is of a suitable viscosity for processing into a pre-preg.

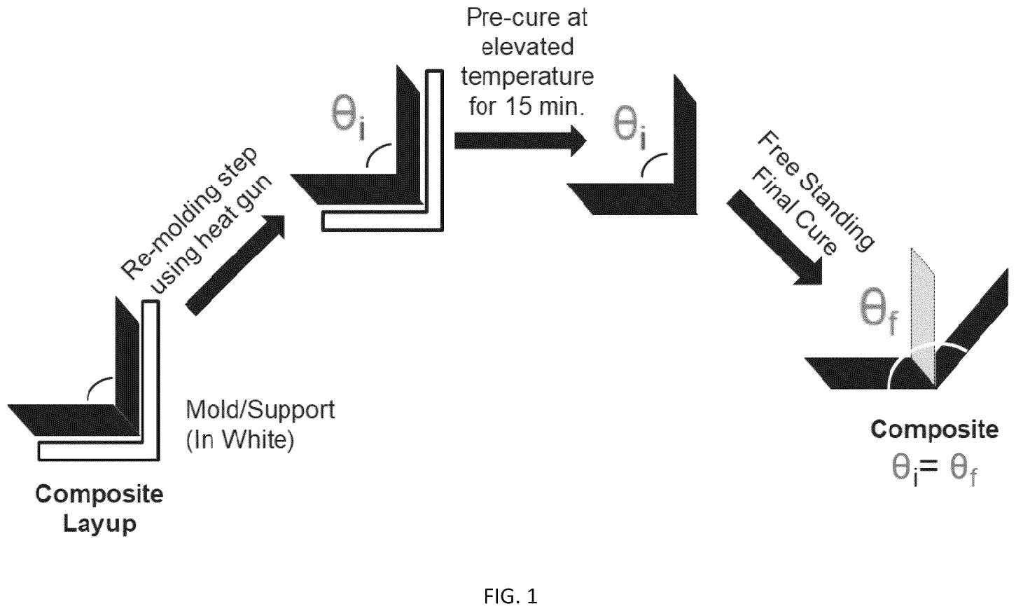

A schematic of the process of molding and curing a pre-preg in accordance with one or more embodiments is shown in FIG. 1. Once a pre-preg is fabricated, it may first be consolidated together into a flat multi-ply pre-form and heated at 140° C.-170° C. for 2-5 minutes. Once the pre-form is at temperature, it can be stamp formed or molded in its uncured state using a mold or support 102. The pre-preg may be re-molded any number of times using mild heating 104. The pre-preg may then be pre-cured at an elevated temperature 106. At this point, the pre-cured pre-preg may be optionally remolded under mild heat to achieve fine-tuning of the shape. Finally, the pre-cured pre-preg may be cured 108 free-standing without physical supports to form the thermoset. The final cured thermoset has the same shape (within +) 10° of the pre-cured pre-preg.

Prior to curing, the pre-preg has thermoplastic properties (i.e., as if it is a pre-preg formed from a thermoplastic resin). As is typically the case with thermoplastic pre-pregs, it can be molded into a desired shape under mild heating, but it does not hold a specific shape when cured, and equipment such as a mold or vacuum bag is required in order to cure the pre-preg into a thermoset having a particular shape. Thus, the pre-preg may be formed into a particular shape, such as with a mold, in an uncured state 102. This initial shaping step, such as by using a mold, provides a general shape for the pre-preg and may be conducted at slightly elevated temperatures (e.g., up to about 150° C.). The initial shape may be re-shaped or re-molded 104 any number of times by reheating to render the composite pliable.

Advantageously, in accordance with one or more embodiments, the pre-preg disclosed herein may be pre-cured 106 to form a moldable part that is capable of being cured in a free-standing state. Pre-curing, as used herein, means that the pre-preg is heated to a sufficient temperature for a sufficient time to partially cure the pre-preg. A partially-cured pre-preg is a pre-preg that has been cured (crosslinked) to less than 100% of the total curing extent, as determined by differential scanning calorimetry (DSC).

The extent of curing is calculated by first calculating the reaction enthalpy (J/g) by adding all the integrals of each exothermic curve generated from a DSC profile for each specimen (e.g. W/g vs Temperature). The reaction enthalpy of an uncured sample is determined from DSC. The extent or degree of curing is calculated by taking the difference between the reaction enthalpy of the un-cured specimen from the reaction enthalpy of a cured specimen from DSC. This difference is divided by the reaction enthalpy of the uncured specimen to obtain the degree of curing of the cured specimen.

In a pre-cured state, the pre-preg may be cured to an extent ranging from about 2% to 80%. In one or more embodiments, the amount of curing of the pre-cured pre-preg may have a lower limit of one of 2%, 5%, 7%, 9%, 10%, 12%, 15%, 20%, and 25%, and an upper limit of one of 27%, 30%, 35%, 40%, 45%, 50%, 60%, 70%, and 80% as measured via DSC, where any lower limit may be paired with any upper limit. In one or more particular embodiments, the pre-preg may be pre-cured to an extent of up to 80% and still achieve moldable properties.

The pre-curing step may be conducted at a suitable temperature for a sufficient time to pre-cure the pre-preg. The curing time and temperature depend on the composition of the pre-preg, including the type and quantity of thermoplastic resin(s), thermosetting resin(s), and fibers. In one or more embodiments, the pre-curing step may be conducted at a temperature ranging from about 100° C. to 220° C. In one or more embodiments, the pre-cure temperature may have a lower limit of one of 100° C. 110° C. 120° C. 130° C., 140° C., 150° C., and 160° C., and an upper limit of one of 170° C. 180° C. 190° C. 200° C., 210° C., and 220° C., where any lower limit may be paired with any upper limit. In one or more embodiments, the pre-curing time may be from about 2 minutes to 2 hours and may be adjusted based upon the desired extent of curing in the pre-cure step.

As used herein, “moldable” means that the pre-cured pre-preg is pliable at slightly elevated temperatures (e.g., around 150° C.) after the pre-curing step. Mild heat may be applied to portions of (or the entirety of) the pre-preg, such as with an oven or a heat gun, in order to render the pre-cured pre-preg pliable or moldable. This allows for repeated re-shaping and greater design flexibility for the pre-preg shape. As the pre-preg cools after it is molded, it may harden such that it holds its shape. The pre-preg may be molded any number of times into different shapes by re-heating the pre-cured pre-preg and re-molding it. In a pre-cured state, the pre-cured pre-preg has thermoplastic properties when analyzed using dynamic mechanical analysis (DMA). In DMA, a pre-cured pre-preg has a glass transition temperature (Tg) and a melting temperature (Tm).

Once the pre-cured pre-preg is molded into a final shape for curing, it may be stored at room temperature until it is cured into a thermoset. Such curing may occur when the pre-cured pre-preg is in a free-standing state. As used herein, “a free-standing state” means that the pre-cured pre-preg may hold its shape during the final curing step without physical supports. As defined herein, a pre-preg holds its shape if it maintains an angle within about 10 degrees of the initial angle during the curing process. For example, if a pre-preg has a 90° angle bend prior to curing, the final shape after free-standing curing will have an angle of between 80° and 100°.

Once a final shape has been achieved either through an initial shaping with a mold or in additional shaping after a pre-curing step, the pre-preg may be cured into a thermoset in a free-standing state 108. The final curing step generally uses a slow ramp rate to ramp to the curing temperature. For example, the ramp rate during the curing step may be from about 0.5 to 2° C. per minute. The curing temperature may be appropriately selected based on the formulation of the resin in the pre-preg. In one or more embodiments, the final curing step may be conducted at a temperature ranging from about 200° C. to 250° C. for a time ranging from 30 to 60 minutes. As noted previously, due to the unique properties of the pre-pregs disclosed herein, the pre-preg may undergo the final curing step in a free-standing state, meaning no molds, vacuum bags, or other equipment are required. This property is particularly advantageous because many different parts having varying shapes and sizes can be cured together in a simple oven curing process.

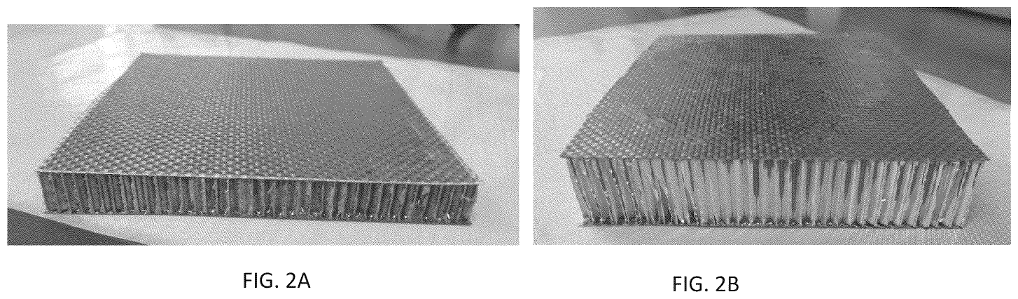

Pre-pregs in accordance with the present disclosure may also be welded/co-cured to different substrates. For example, the pre-preg may be welded/co-cured to aluminum honeycomb cores and aramid honeycomb cores in one or more embodiments, examples of which are shown in FIGS. 2A and 2B. In such embodiments, an additional layer of the thermoplastic-thermosetting resin film may be applied between the core surface and the pre-preg plies, for example. As used herein, “welding” means the joining of materials using heat and/or pressure to melt or soften parts that are in contact, thereby creating a physical or chemical bond. As used herein, “co-curing” is defined as the joining of materials by curing of parts in contact to create a chemical bond.

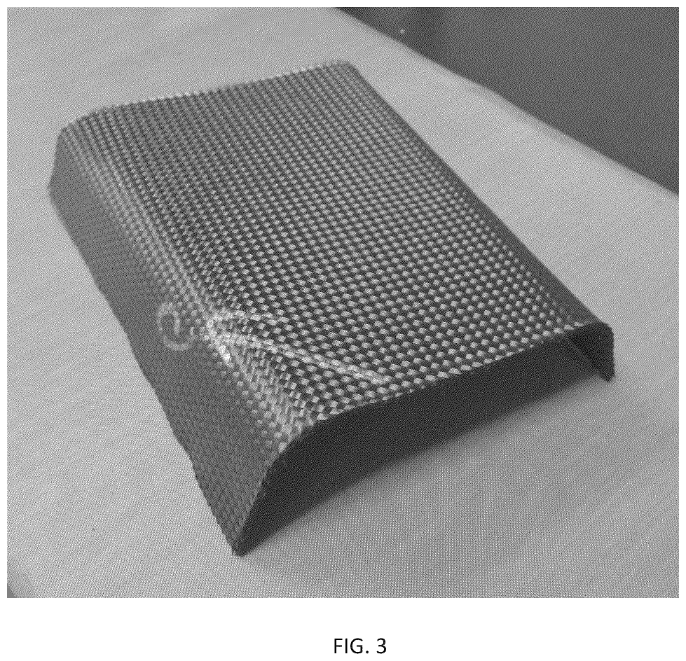

After the final curing step, a composite article having thermoset properties may be formed, an example of which is shown in FIG. 3. When analyzed using DMA, a final cured article no longer has a Tm, as is the case with a pre-cured composite, and only has a Tg. The composite may have a high degree of crosslinking and thus may also have advantageous properties such as high modulus and superior creep. Once it has been fully cured, the composite cannot be reshaped upon heating. The composite articles may be suitable for various industries such as aerospace, automotive, marine, locomotive, bicycle frame, satellites, defense, and consumer electronics.

### Examples

### Methods

Differential scanning calorimetry (DSC) measurements were carried out using a Q20 DSC model from TA Instruments at a heating rate of 10° C./min in a N₂ atmosphere.

Dynamic mechanical analysis (DMA) measurements were conducted using an DMA 850 model from TA instruments at a heating rate of 3° C./min in the range of 50 to 300° C. and a fixed frequency of 1 Hz. A sinusoidal strain amplitude of 0.05% was used for the analysis. Dimensions of the rectangular samples were 35-40 mm×5 mm. Tg was measured from an onset of a storage modulus curve (intersection of two tangent lines before and after an inflection point).

Melt viscosity was measured using a rheometer (DHR-2, TA instruments) with a heating rate of 5° C./min, an angular frequency of 6.283 rad/s (1.0 Hz), and a strain of 0.1%. A parallel plate having a 25 mm diameter was used. Measurements were carried out in air. Viscosity was measured in accordance with ASTM D7891.

### Synthesis of BP5-6

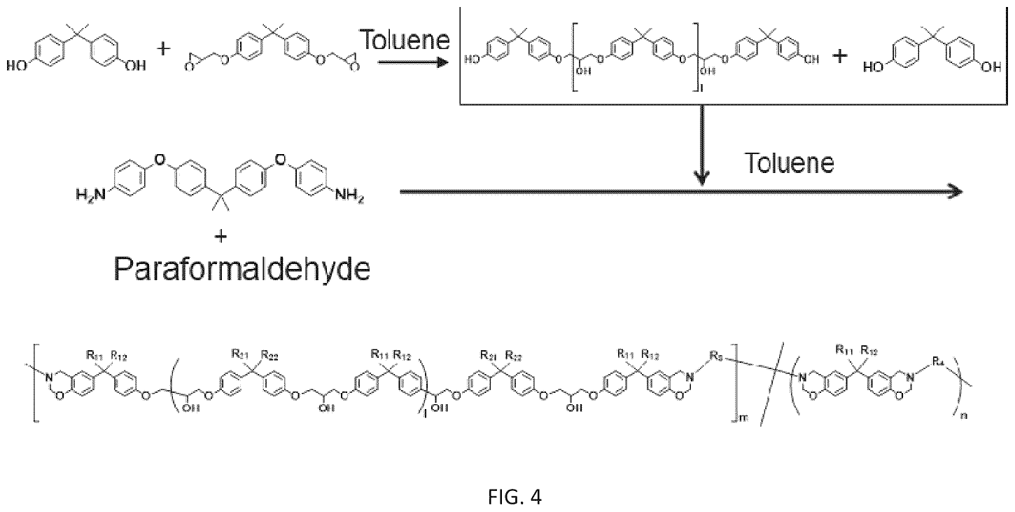

The BP5-6 crosslinkable thermoplastic was made in accordance with the methods described in Japanese Patent Application Number 2021-177095, filed on Oct. 29, 2021, which is incorporated by reference herein in its entirety. A synthetic scheme in accordance with one or more embodiments is shown in FIG. 4.

### Synthesis of Pre-Preg Resin Composition

The pre-preg resin was made by mixing BP5-6 (crosslinkable thermoplastic), epoxy resin, benzoxazine monomer, and catalyst. The different blend ratios are shown in Table 1. All quantities are reported in weight percent. The weight percentages of the BP5-6, epoxy, and benzoxazine monomer are based on the total amount of resin in the composition (i.e., the total amount of BP5-6, epoxy, and benzoxazine monomer). The mass of the catalyst is based on the total amount of epoxy resin and benzoxazine monomer (i.e., the total amount of thermosetting resin).

TABLE 1
Resin Compositions

| Sample | BP5-6 | Epoxy | Benzoxazine | Catalyst |
|---|---|---|---|---|
| 1 | 80 | 12 | 8 | 2 |
| 2 | 70 | 18 | 12 | 2 |
| 3 | 60 | 24 | 16 | 2 |
| 4 | 50 | 30 | 20 | 2 |
| 5 | 40 | 36 | 24 | 2 |

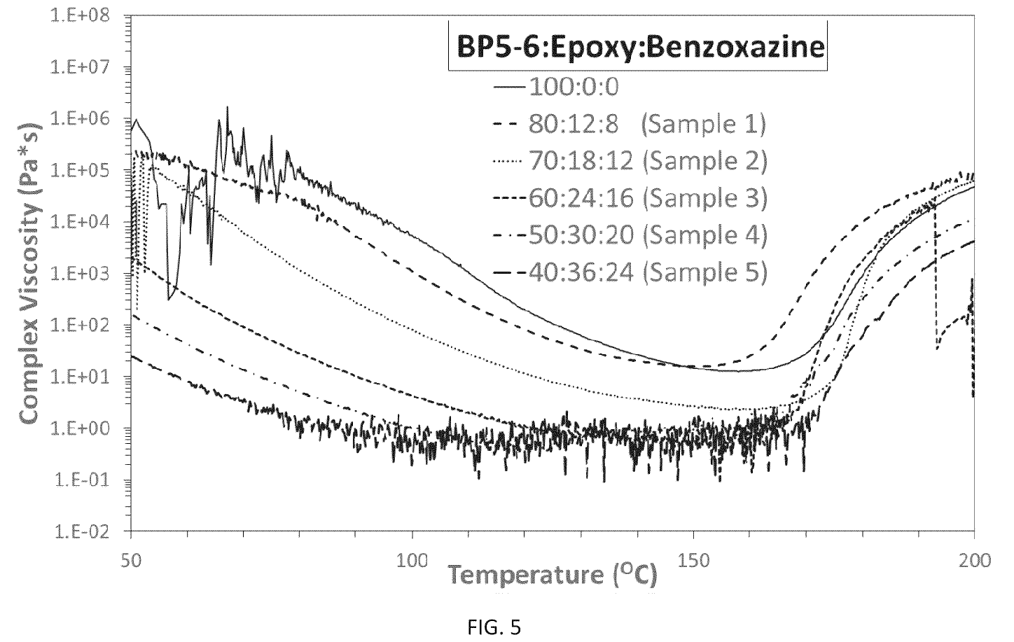

The viscosity of each of the resin compositions was tested and the results are shown in FIG. 5. As shown in FIG. 5, as the quantity of the thermoplastic resin (BP5-6) decreases, the viscosity also decreases, demonstrating that increasing the relative amount of the thermosetting resin decreases overall viscosity.

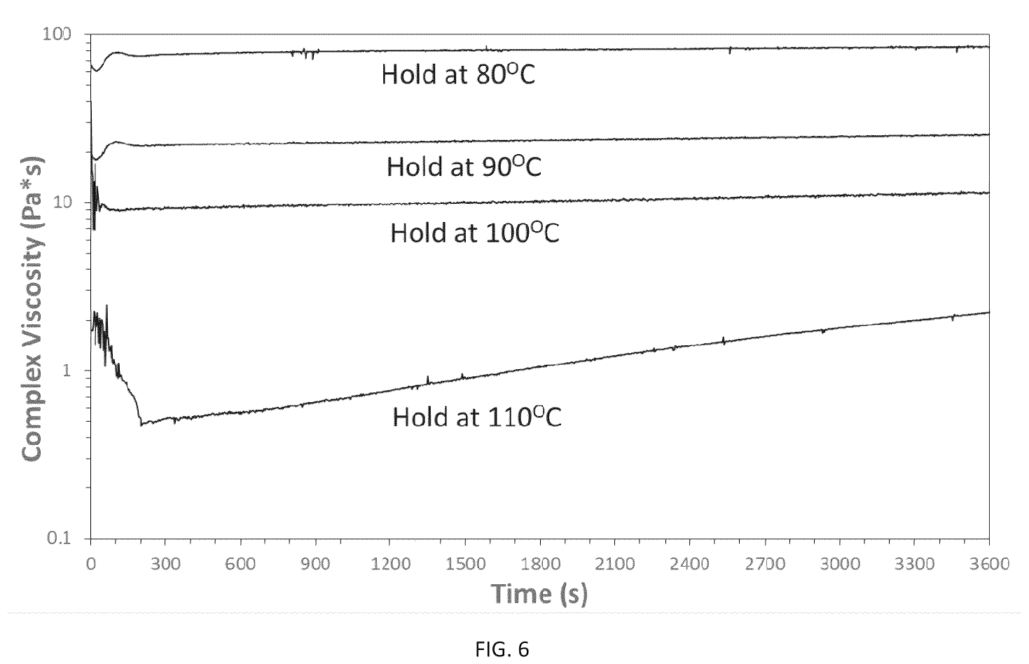

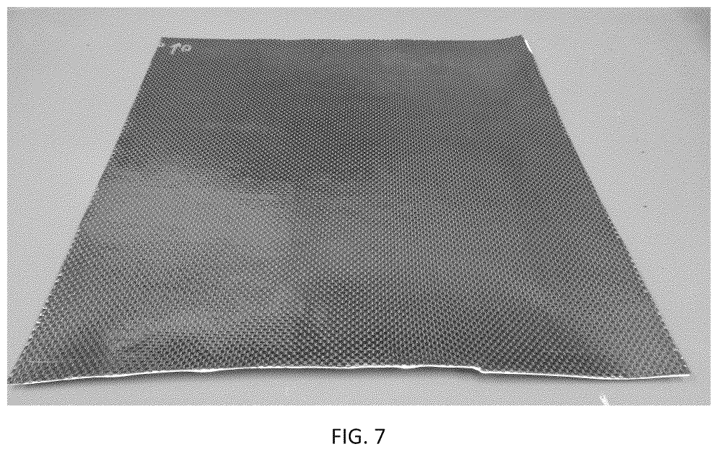

The resin formulation of Sample 3 was used for additional rheological testing. The resin of sample 3 was held at a constant temperature for 1 hr for each test (i.e. 80° C., 90° C., and 100° C.). The viscosity versus time profile at each test temperature was used to verify the viscosity profile during temperatures used in the pre-impregnation process. The results are shown in FIG. 6. 100° C. was determined to be an acceptable temperature for processing the pre-preg, because the viscosity of the resin remained stable and was within an acceptable viscosity range for the pre-impregnation process. A processed pre-preg ply is shown in FIG. 7.

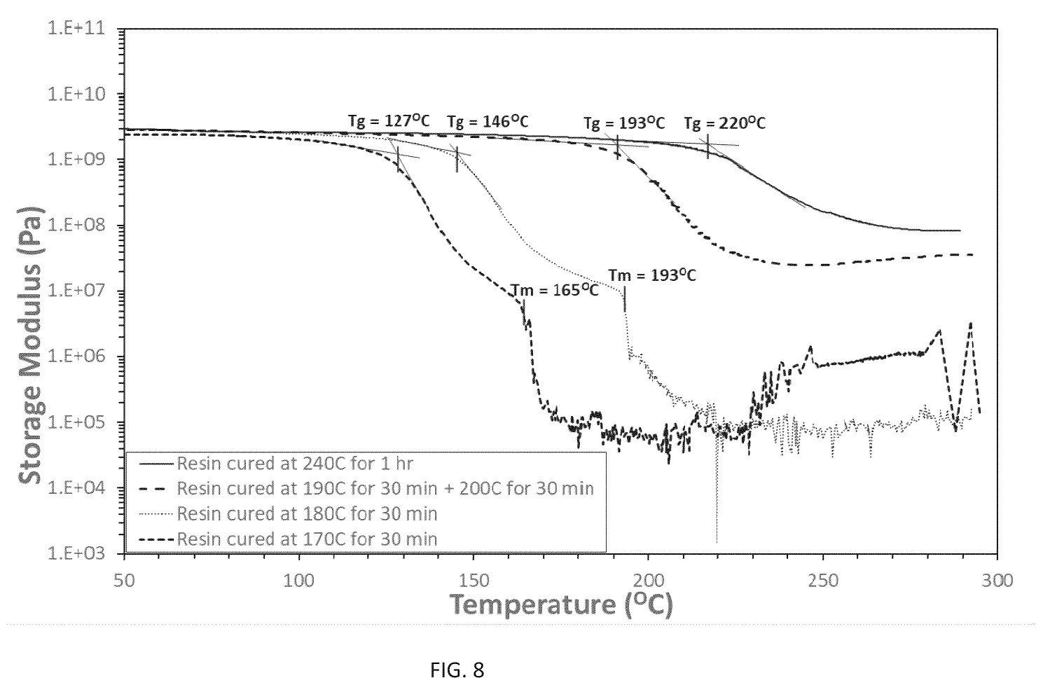

Evaluation of the storage modulus (E′) as a function of temperature was performed using DMA on the resin system of Sample 3 to show both thermoplastic (at a lower pre-curing temperature) and thermoset (at higher curing temperature) properties. FIG. 8 shows the modulus versus temperature profile for resin sample 3 that was subjected to several curing profiles. It was partially-cured (specifically at temperatures of 170° C., 180° C., or 190° C.) or fully-cured (i.e., at 240° C.). The partially-cured profiles exhibit thermoplastic behaviours where the curves show a Tg transition temperature and a Tm transition temperature. The fully-cured profile exhibits thermoset behaviours where the curve shows a Tg transition temperature only.

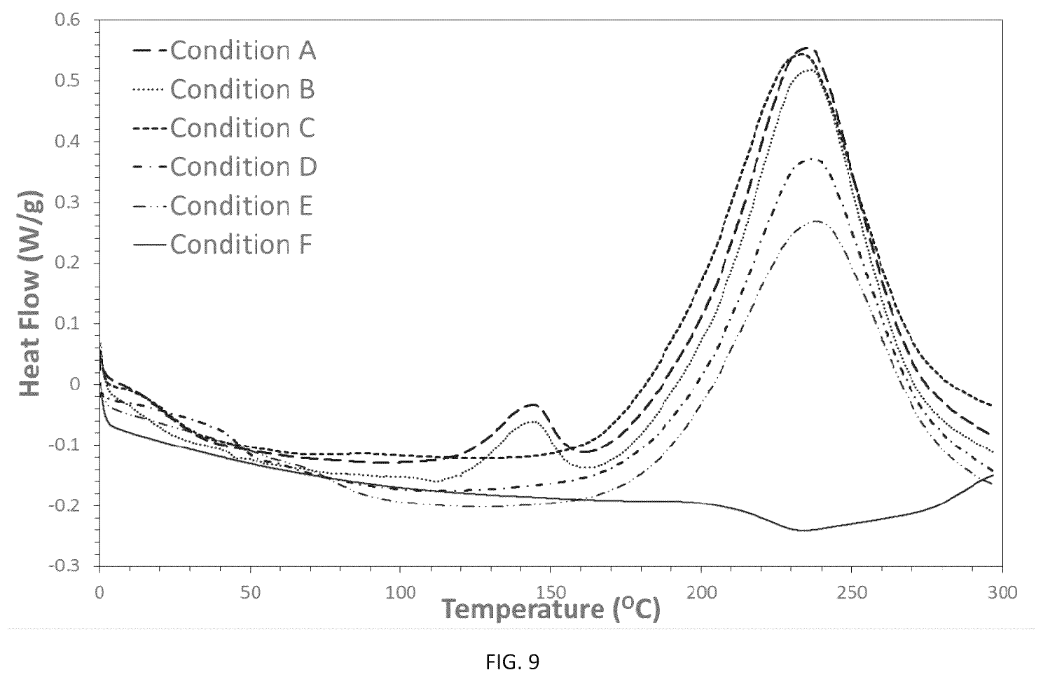

The degree of re-moldability at different cure temperatures is shown by the DSC data for degree of cure in FIG. 9. FIG. 9 shows the heat flow generated from different cured states of the resin system of sample 3. A neat sample 3 resin (i.e., no curing) was used as a baseline. The samples were cured at the conditions shown in Table 2.

TABLE 2
Curing Conditions

| | Curing time | Curing time | Curing time | Curing time | Curing time | |
|---|---|---|---|---|---|---|
| Curing | at 100° C. | at 150° C. | at 170° C. | at 180° C. | at 220° C. | Degree of |
| Condition | (min) | (min) | (min) | (min) | (min) | Cure (%) |
| A | N/A | N/A | N/A | N/A | N/A | 0 |
| B | 2 | N/A | N/A | N/A | N/A | 9 |
| C | 2 | 2 | N/A | N/A | N/A | 9 |
| D | 2 | 2 | 15 | N/A | N/A | 22 |
| E | 2 | 2 | N/A | 15 | N/A | 36 |
| F | 2 | 2 | N/A | 15 | 60 | 100 |

As shown in Table 2, at low cure temperatures (i.e., 100° C. and 150° C.), the material has about 9% degree of cure. Therefore, the material has low amounts of cross-linking, and is still at a thermoplastic dominated state for re-moldability. At the pre-cure temperatures of 170° C. and 180° C., the degree of cure is higher (22%-36%), such that thermoplastic functionality is still present for re-moldability. The fully-cured state (i.e., cured at 220° C.) exhibits 100% degree of cure with no heat flow as a function of temperature. At this state, the cross-linking is complete, and the resin behaves as a cured thermoset that cannot be re-molded further.

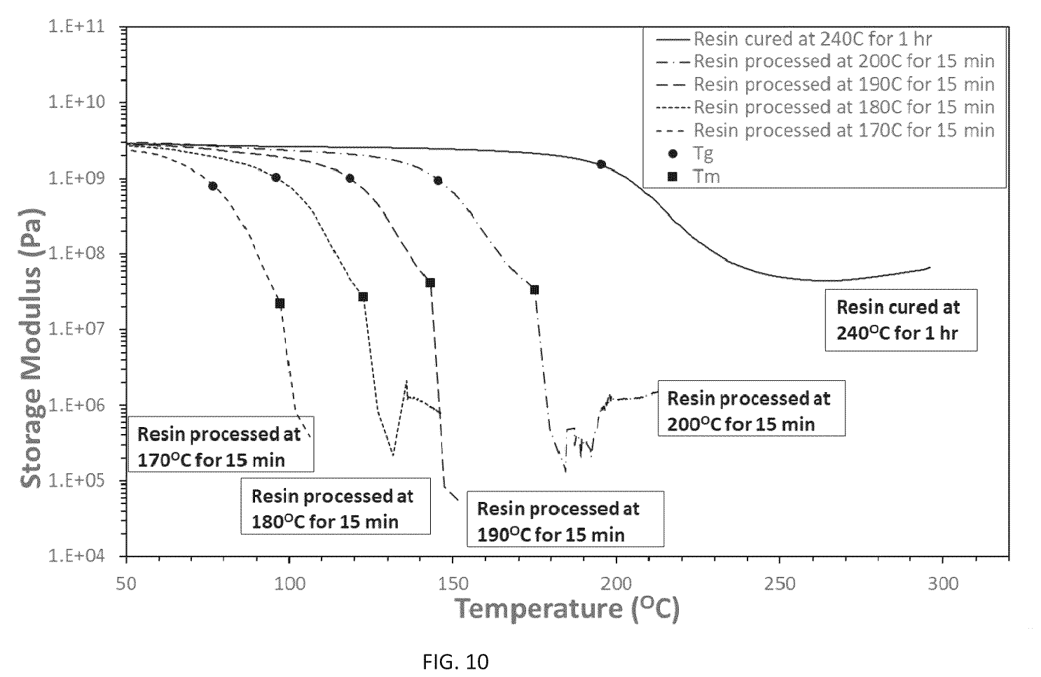

DMA data showing modulus versus temperature of the sample 2 resin is shown in FIG. 10. The re-molding capability of the sample 2 resin is shown to exist up to the pre-cure temperature of 200° C. for 15 minutes, as shown in FIG. 10. The modulus versus temperature profiles, with the Tg and Tm transition points present, signify that the resin exhibits re-molding capability after molding the pre-preg into the free standing shape but prior to curing. A neat sample 2 resin (i.e., no curing) was used as a baseline. The samples were cured at the conditions shown in Table 3.

TABLE 3
Curing Conditions

| Curing | Curing | Curing | Curing | Curing | Curing | |
|---|---|---|---|---|---|---|
| time at | time at | time at | time at | time at | time at | |
| 150° C. | 170° C. | 180° C. | 190° C. | 200° C. | 240° C. | Degree of |
| (min) | (min) | (min) | (min) | (min) | (min) | Cure (%) |
| N/A | N/A | N/A | N/A | N/A | N/A | 0 |
| 2 | 15 | N/A | N/A | N/A | N/A | 35 |
| 2 | N/A | 15 | N/A | N/A | N/A | 57 |
| 2 | N/A | N/A | 15 | N/A | N/A | 65 |
| 2 | N/A | N/A | N/A | 15 | N/A | 81 |
| N/A | N/A | N/A | N/A | N/A | 60 | 100 |

Pre-pregs were made using the resin composition of sample 3. In order to make a pre-preg, the resin (in powder or coagulated form) was heated at 100° C.-110° C. until it melted into a low viscosity gel form. The resin was continuously loaded into a filming machine, held at 100° C.-120° C., and pressed into a film using nip or pinch rollers. The film of resin produced was used to impregnate fabric sheets using a continuous process. The fabric and films (one on top and one on the bottom of the fabric) were fed into an impregnation machine at 100° C.-120° C. to compress the resin films into the fabric sheet using nip or pinch rollers.

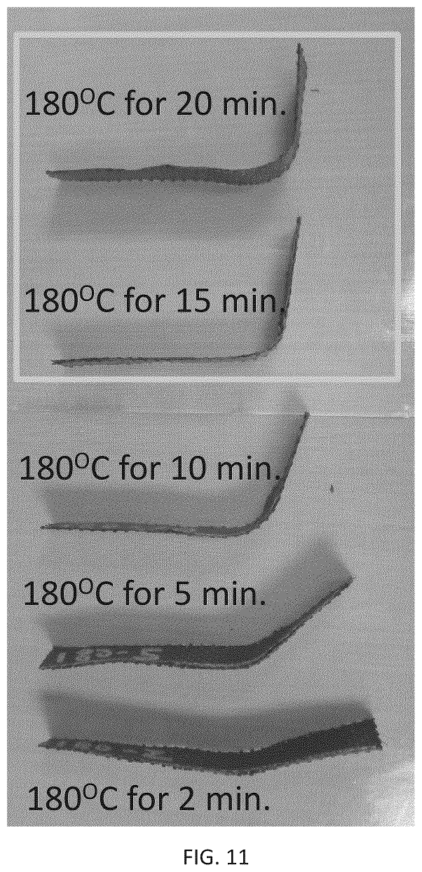

Various laminates were made using the resin formulation of Sample 3 and different pre-cure temperatures were evaluated. Each laminate was formed to about a 90° angle to study the ability of the laminates to be cured in a free-standing state. FIG. 11 shows various cured thermosets that were subjected to the same pre-cure temperature of 180° C. for varying times. In particular, from top to bottom, the pre-cure conditions were 180° C. for 20 minutes, 180° C. for 15 minutes, 180° C. for 10 minutes, 180° C. for 5 minutes, and 180° C. for 2 minutes. As shown, the thermosets that were subjected to 15 or 20 minutes of pre-cure at 180° C. were able to produce a fully free-standing state after final cure. The rest experienced some change in the angle from the pre-cured laminate to the thermoset.

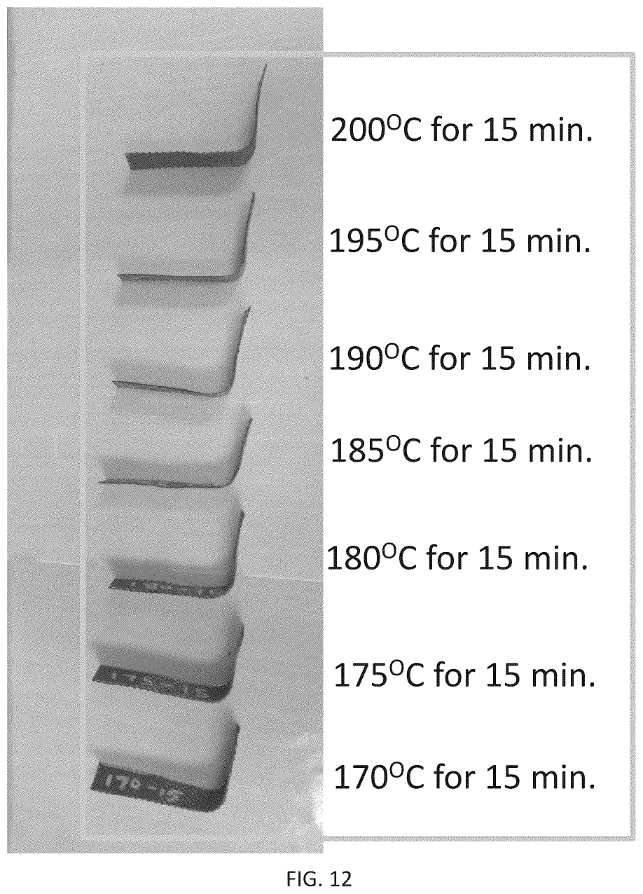

FIG. 12 shows cured thermosets made from laminates that were pre-cured at different temperatures for 15 minutes. Specifically, from top to bottom, the laminates were pre-cured at a temperature of 200° C., 195° C., 190° C., 185° C., 180° C., 175° C., and 170° C. for 15 minutes each. The laminates that were pre-cured at temperatures from 170° C. to 200° C. held their shape best during cure.

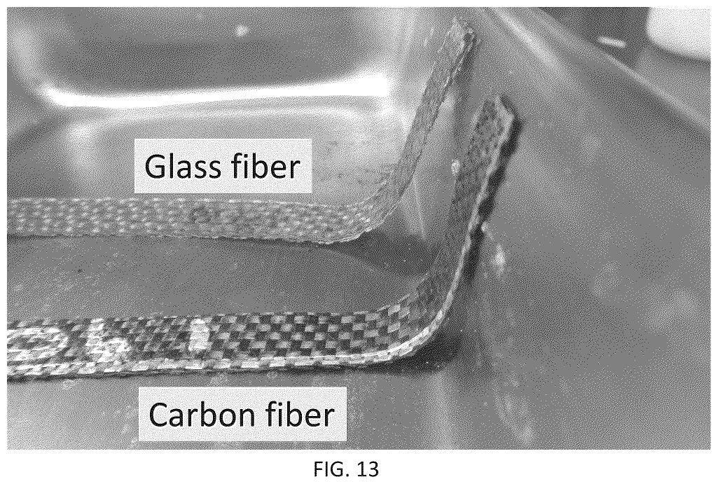

Additionally, different fiber materials were tested for their ability to hold their shape in a free-standing curing process. The carbon fiber material, which has a negative CTE, maintains its free standing state after cure more readily than a glass fiber material, which has a positive CTE. As shown in FIG. 13, there was an angular difference of about 10 degrees between a glass fiber composite versus a carbon fiber composite system.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

What is claimed:

1. A pre-preg composite, comprising:
a thermoplastic-thermosetting resin composition comprising:
a crosslinkable thermoplastic resin; and
a thermosetting resin; and
fibers;
wherein the pre-preg composite is capable of being cured in a free-standing state,
wherein the crosslinkable thermoplastic resin comprises a benzoxazine resin, and
the thermoplastic resin is included in the composition in an amount ranging from 40 to 99 wt. % based on the total amount of thermoplastic-thermosetting resin.

2. The pre-preg composite of claim 1, wherein the thermoplastic-thermosetting resin composition further comprises a catalyst.

3. (canceled)

4. The pre-preg composite of claim 1, wherein the benzoxazine resin comprises a structure as shown in formula (II): 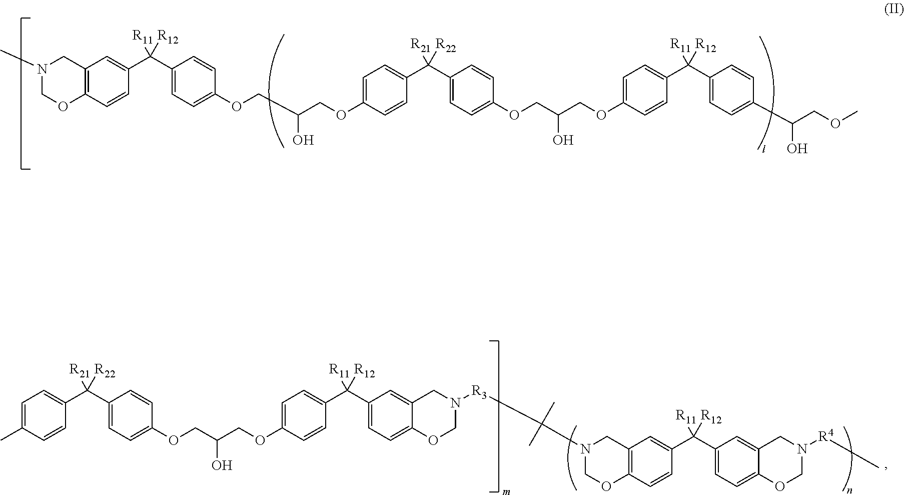
wherein each of R₁₁, R₁₂, R₂₁ and R₂₂ is a hydrogen atom or a hydrocarbon group, and wherein R₃ and R₄ are independently selected from the group consisting of diamine compounds having 6 to 27 carbon atoms, aliphatic or alicyclic diamine compounds having 6 to 24 carbon atoms, silicone based diamine compounds, and combinations thereof.

5. The pre-preg composite of claim 1, wherein the thermosetting resin comprises a resin selected from the group consisting of an epoxy resin, a benzoxazine resin, and combinations thereof.

6. The pre-preg composite of claim 1, wherein the fibers are selected from the group consisting of carbon fiber, glass fiber, metal fiber, ceramic fiber, aramid fiber, polyamide fiber, polyester-based fiber, polyolefin-based fiber, novoloid fiber, and combinations thereof.

7. (canceled)

8. The pre-preg composite of claim 1, wherein the thermosetting resin is included in the composition in an amount ranging from 1 to 60 wt. % based on the total amount of thermoplastic-thermosetting resin.

9. The pre-preg composite of claim 1, wherein the thermoplastic-thermosetting resin has a complex viscosity ranging from 0 to 1000 Pa·S in a temperature ranging from 50 to 140° C. when tested according to ASTM D7891.

10. A method of forming a thermoset article, the method comprising:
providing the pre-preg composite of claim 1;
pre-curing the pre-preg composite such that the pre-preg composite is cured to an extent of from 2% to 80%; and
curing the pre-cured pre-preg composite to form the thermoset article.

11. The method of claim 10, further comprising, before pre-curing, molding the pre-preg composite.

12. The method of claim 10, further comprising, after pre-curing, molding the pre-preg into a free-standing shape, wherein the curing is conducted in the free-standing state.

13. The method of claim 12, further comprising, after molding the pre-preg into the free-standing shape but prior to curing, re-molding the pre-preg.

14. The method of claim 10, further comprising, welding and/or co-curing the pre-preg to an aluminum honeycomb core or an aramid honeycomb core.

15. A cured article made from the method of claim 10.

16. A method of making a pre-preg composition, the method comprising:
impregnating fibers with a thermoplastic-thermosetting resin composition, the thermoplastic-thermosetting resin composition comprising:
a crosslinkable thermoplastic resin; and
a thermosetting resin;
wherein the pre-preg composition is capable of being cured in a free-standing state.

17. The method of claim 16, wherein the impregnating is conducted at a temperature ranging from 80° C. to 140° C. and a pressure of 0.5 MPa-3.5 MPa.
